(19) United States
(12) Patent Application Publication
(10) Pub. No.: US 2020/0183060 A1
(43) Pub. Date: Jun. 11, 2020

(54) TEXTURE STRUCTURE, OPTICAL THIN FILM, MOULD AND ELECTRONIC DEVICE COVER PLATE

(71) Applicant: Shine Optoelectronics (Kunshan) Co., Ltd., Kunshan City (CN)

(72) Inventors: Yulong Gao, Kunshan City (CN); Shen Hong, Kunshan City (CN); Su Shen, Kunshan City (CN); Hongwei Kang, Kunshan City (CN)

(21) Appl. No.: 16/787,180

(22) Filed: Feb. 11, 2020

Related U.S. Application Data
(63) Continuation of application No. PCT/CN2018/090758, filed on Jun. 12, 2018.

(30) Foreign Application Priority Data
Aug. 11, 2017 (CN) 201710686871.7

(51) Int. Cl. G02B 5/10; G02B 5/08

(52) U.S. Cl. CPC G02B 5/10; B44C 5/0453; G02B 5/0808

(57) ABSTRACT

The present invention discloses a texture structure, an optical thin film, a mould and an electronic device cover plate. The texture structure comprises a plurality of distributed short lines, the plurality of short lines are arranged to be protruded and/or depressed, a gap is provided between adjacent short lines, and the gap forms an optical structure. The present invention provides a new texture structure, of which a direction of the short lines can be changed in a certain direction randomly or according to an expected effect, a side surface of the short line being an arc-shaped surface, adjacent arc-shaped surfaces connecting with each other to form a gap, and the gap being an optical structure, and provides an optical thin film having the texture structure, the optical thin film using this texture having at least one light beam under a certain light source and reducing to a certain extent the influence of rainbow streaks on light-shadow effects, and also provides an electronic device cover plate using the texture structure or the optical thin film, by which the rotational angles of the short lines can be used flexibly to realize different light-shadow effects of the electronic device cover plate.

### CROSS REFERENCE TO RELATED APPLICATIONS

This application is a continuation of International Application No. PCT/CN2018/090758, filed on Jun. 12, 2018, which claims the priority of the Chinese patent application No. 201710686871.7, filed on Aug. 11, 2017, both of which are hereby incorporated by reference in their entireties.

### TECHNICAL FIELD

The present invention relates to the technical field of texture, optical thin films and device cover plates, in particular to a texture structure, an optical thin film, a mould and an electronic device cover plate.

### BACKGROUND

As science and technology develop, decorative films are widely used on surfaces of electronic products such as mobile phones and computers, of household appliances such as refrigerators, air conditioners and washing machines, and of automobiles.

Existing decorative films are used as surface materials for mobile machines such as mobile phones and laptops, and as surface materials for household appliances such as refrigerators, washing machines and air conditioners. A variety of texture patterns and metallic feelings are presented by intaglio printing.

Existing decorative textures are generally cylindrical mirrors or printed patterns. However, the resolution of printed patterns is not very high, and when cylindrical mirrors are adopted, rainbow streaks generally occur to interfere the effect of the cylindrical mirrors. So, there is a necessity to develop a new decorative texture.

### SUMMARY

On this basis, it is necessary to provide a texture structure, an optical thin film, a mould and an electronic device cover plate to solve the above technical problems.

One technical solution of the present invention is given below.

The present invention provides a texture structure, comprising a plurality of distributed short lines arranged to be protruded and/or recessed, a gap being formed between adjacent short lines, the gap forming an optical structure.

In one embodiment, there are at least two short lines forming included angles a and b with a horizontal direction, and the included angle a is not equal to the included angle b.

In one embodiment, there are at least two short lines, of which one short line is deflected and/or offset with respect to the other.

In one embodiment, the plurality of short lines are arranged in an array, the short lines in the same row are arranged to be deflected at increasing or decreasing deflection angles.

In one embodiment, there is at least one region, in the same row, in which the deflection angles of the short lines change in an equal difference manner.

In one embodiment, there is at least one region, in the same row, in which the deflection angles of the short lines change in an equal difference manner from 0 to 180 degrees, or from 45 to 90 degrees, or from 0 to 270 degrees.

In one embodiment, the short line includes a top plane or a bottom plane, and a side surface surrounding the top plane or bottom plane, the side surface being an arc-shaped surface.

In one embodiment, the top plane or bottom plane is triangle, quadrangle, circle or polygon.

In one embodiment, the arc-shaped surfaces of two adjacent short lines are connected to form the gap.

In one embodiment, the top plane or bottom plane of the short line is a rectangle, and each short line is deflected from the intersection point of the two diagonals of the rectangle.

In one embodiment, distances between the intersection points of adjacent short lines are equal.

In one embodiment, the top plane or bottom plane of the short line is a rectangle, and in the same row, the length of the rectangle is constant while the width of the rectangle varies.

In one embodiment, the optical structure presents at least one light-shadow bright streak.

The present invention provides an optical thin film having a texture structure as described above, the optical thin film comprising a polymer layer on which the texture structure is formed.

In one embodiment, the polymer layer is a heat-cured or light-cured adhesive layer, and the texture structure is a plurality of short lines formed by embossing on the heat-cured or light-cured adhesive layer and gaps between the short lines.

In one embodiment, the light-cured adhesive layer is a UV adhesive layer, or the light-cured adhesive layer is a colored UV adhesive layer.

In one embodiment, a distance between adjacent short lines is 10 μm-200 μm.

In one embodiment, the polymer layer comprises a first side and a second side that are opposite to each other, the short lines are provided on the first side, and a distance from the short line to a surface on the second side is Oμm-200 μm.

In one embodiment, there are at least two short lines between which a height difference or depth difference is greater than 0.05 μm and not greater than 2 μm.

In one embodiment, the short line has a top plane or a bottom plane, the top plane or bottom plane is a rectangle, the length of the rectangle is 80 μm-150 μm, and the width of the rectangle is 1 μm-120 μm.

In one embodiment, the length of the rectangle is constant, while the width of the rectangle varies in a range of 3 μm-100 μm.

In one embodiment, the texture structure is covered by a reflective layer which in turn is covered by a colored layer, and a carrying layer is provided on a side of the polymer layer opposite to the texture structure.

In one embodiment, the optical thin film is a decorative film.

The present invention provides a mould for manufacturing an optical thin film, comprising:

a supporting body;

a polymer body provided on a side of the supporting body;

a plurality of short lines formed on a side of the polymer body away from the supporting body;

wherein, the plurality of short lines are recessed and/or protruded structures, and a gap is provided between the short lines.

The present invention provides an electronic device cover plate comprising a texture structure as described above.

The present invention provides an electronic device cover plate comprises an optical thin film as described above.

Advantageous effects of the present invention:

(I) The present invention provides a new texture structure, of which the direction of the short lines can be changed in a certain direction randomly or according to a desired effect, and the included angles between the short lines and the horizontal direction can vary from 0 to 180 degrees. The side surface of the short line is an arc-shaped surface, adjacent arc-shaped surfaces connect with each other to form a gap, and the gaps are an optical structure.

(II) The present invention provides an optical thin film with this texture structure. The optical thin film using this texture at least has one light beam under a certain light source, and reduces to a certain extent the influence of rainbow streaks to the light-shadow effect.

(III) The present invention provides an electronic device cover plate using the texture structure or the optical thin film, by which the rotational angle of the short lines can be utilized flexibly to realize different light-shadow effects of the electronic device cover plate.

### BRIEF DESCRIPTION OF THE DRAWINGS

FIG. 1 is a schematic structure diagram of an electronic device cover plate according to the present invention;

FIG. 2 is a schematic structure diagram of one of the texture structure arrangements according to the present invention;

FIG. 3 is a schematic diagram of a texture structure according to the present invention;

FIG. 4 is a schematic diagram of the sectional structure of an optical thin film including the texture structure according to the present invention;

FIG. 5 is another schematic diagram of the sectional structure of an optical thin film according to the present invention;

FIG. 6 is another schematic diagram of the sectional structure of an optical thin film according to the present invention;

FIG. 7 is another schematic diagram of the sectional structure of an optical thin film according to the present invention;

FIG. 8 is another schematic diagram of the sectional structure of an optical thin film according to the present invention;

FIG. 9 is another schematic diagram of the sectional structure of an optical thin film according to the present invention;

FIG. 10 is another schematic diagram of the sectional structure of an optical thin film according to the present invention;

FIG. 11 is another schematic diagram of the sectional structure of an optical thin film according to the present invention;

FIG. 12 is another schematic diagram of the sectional structure of an optical thin film according to the present invention;

FIG. 13 is a schematic diagram of the sectional structure of a mould for manufacturing an optical thin film according to the present invention;

### DETAILED DESCRIPTION

To facilitate the understanding of the present invention, a more comprehensive description of the present invention is made in the following with reference to the relevant accompanying drawings. The accompanying drawings provide preferred embodiments of the present invention. However, the present invention can be implemented in various different forms and is not limited to the embodiments described below. On the contrary, the purpose of providing these embodiments is to enable a more thorough and comprehensive understanding of the disclosure of the present invention.

It should be explained that when an element is referred to as being “provided on” another element, it can be directly on the other element, or an intervening element may also exist. When an element is referred to as being “connected to” another element, it can be directly connected to the other element, or an intervening element may also exist at the same time. The terms “vertical”, “horizontal”, “left” and “right” as well as other similar expressions used in this text are for the purpose of explanation only and do not represent an unique embodiment.

Unless otherwise defined, all technical and scientific terms used in this text have the same meaning as commonly understood by the skilled persons belonging to the technical field of the present invention. The terms used in the Description of the present invention are for the purpose of describing the specific embodiments only, and are not intended for limiting the present invention. The term “and/or” used in this text includes any and all combinations of one or more of the associated listed items.

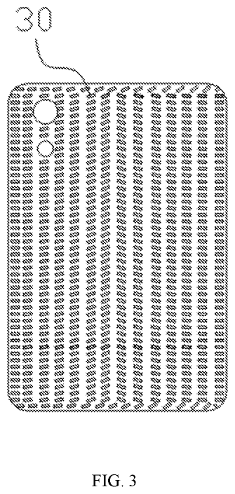

Referring to FIG. 3, the present invention discloses a texture structure comprising a plurality of distributed short lines 30. The plurality of short lines 30 are provided to be protruded and/or recessed, a gap is provided between adjacent short lines 30, and the gap forms an optical structure, and thereby a light-shadow effect can be produced. For example, a light-shadow bright streak moving with an angle can be observed under a single light source.

In one embodiment, there are at least two short lines 30 forming included angles a and b with a horizontal direction, and the included angle a is not equal to the included Angle b. The short lines 30 can rotate according to one angle (i.e. all short lines 30 form the same included angle with the horizontal direction), or the short lines 30 can rotate at different angles such that the included angles between the short lines 30 and the horizontal direction are different.

In one embodiment, there are at least two short lines 30, of which one short line is deflected and/or offset with respect to the other, i.e. the two short lines are not in one row or one column and are staggered from each other in position, or, the two short lines are in one row or column but have different deflection angles, or are staggered from each other and have different deflection angles, etc.

In one embodiment, the plurality of short lines are arranged in an array, in which the short lines in the same row are arranged to be deflected and the deflection angle varies, while the short lines in the same column have the same deflection angles. The deflection of the short lines means that the short lines form an included angle with the horizontal direction, or self-rotation of the short lines, or that the short lines form an included angle with the arrangement direction, or deflection produced when one short line serves as a reference and the other short lines deflect with respect to this reference short line, or the like. Preferably, the deflection of the short lines refers to rotation thereof in one plane. To be specific, the deflection angles of the short lines in the same row change in an equal difference manner. Of course, the deflection angles of the short lines may also change in a non-equal difference manner. In the same row, there is a region in which the deflection angle of the short line is 0-180 degrees, in other words, the included angle between the short line and the horizontal direction is 0-180 degrees, or there may be a region in which the deflection angle of the short line is 45-90 degrees. That is, there may be only one period in the same row, for example, the deflection angles of 45-90 degrees of the short lines are one period, and the row includes an array of the period. Also, there may be a plurality of periods in the same row, for example, the deflection angles of 0-90 degrees of the short lines are one period, and the deflection degrees of 45-90 degrees of the short lines are another period. Different periods are arranged alternately, randomly or in other ways in the same row. The initial angle of the deflection angles of the short lines can be selected randomly, subjecting to no special rules. In other embodiments, the deflection angle may vary from 0 to 270 degrees.

In one embodiment, the short line includes a top plane or a bottom plane, and a side surface surrounding the top plane or bottom plane, the side surface being an arc-shaped surface. The arc-shaped surfaces of two adjacent short lines are connected to form the gap. The top plane or bottom plane is triangle, quadrangle, circle or polygon. Preferably, the top plane or bottom plane of the short line is a rectangle, and each short line is deflected from the intersection point of the two diagonals of the rectangle. Distances between the intersection points of adjacent short lines are equal. In order to achieve other light-shadow effects, the short line can also rotate not according to the intersection point of the diagonals, and the distances between the intersection points can also be unequal.

In one embodiment, for the short lines on the same row, the length of the rectangle is constant and the width of the rectangle varies.

In one embodiment, the optical structure presents at least one light-shadow bright streak.

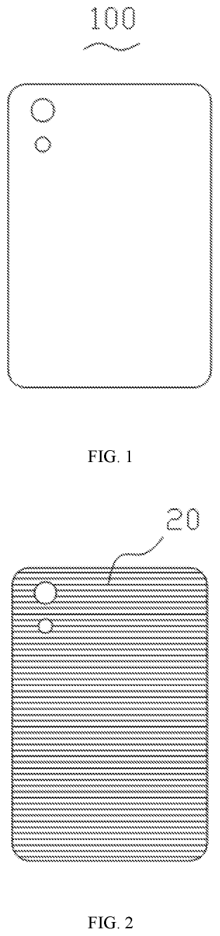

In one embodiment, referring to FIG. 2, the plurality of short lines 30 are arranged in a predetermined arrangement form, which is a linear type 20 or substantially linear type 20, and according to need, different arrangement manners can also be adopted.

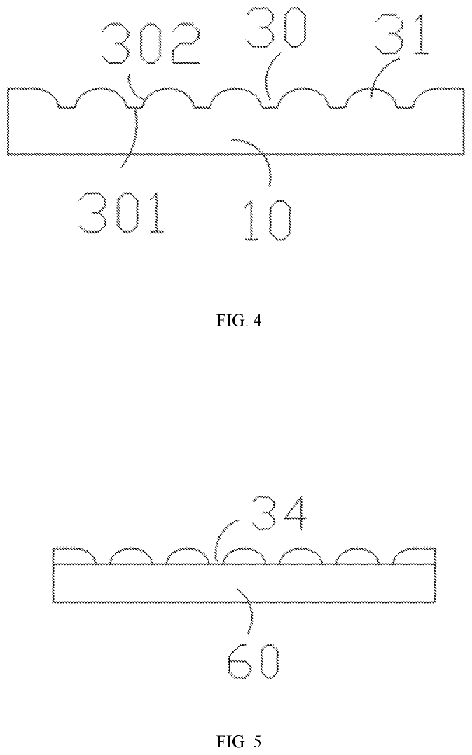

Referring to FIG. 4, the present invention discloses an optical thin film, comprising a polymer layer 10 and a texture structure provided on a surface of the polymer layer 10. The polymer layer 10 and the texture structure are an integral structure.

The polymer layer 10 is a heat-cured or light-cured adhesive layer, and the texture structure is a plurality of short lines formed by embossing on the heat-cured or light-cured adhesive layer and gaps between the short lines. Preferably, the light-cured adhesive layer is a UV adhesive layer, and the texture structure is a plurality of short lines 30 formed by embossing on the UV adhesive layer and gaps 31 between the short lines. In other embodiments, the light-cured adhesive layer is a colored UV adhesive layer. The short lines 30 are recessed structures with a gap 31 formed between adjacent recessed structures. The recessed structure of the short line 30 has a bottom plane 301 and a side surface 302 surrounding the bottom plane 301, the side surface 302 is an arc-shaped surface, and the arc-shaped surfaces of adjacent short lines 30 connect with each other to form the gap 31. By means of the arc-shaped surfaces, the gaps 31 become an optical structure, which produces optical effects under the effect of light.

Please refer to FIG. 10 in which the provided short lines 32 are protruded structures and a gap 33 is provided between adjacent short lines 32. The short line 32 has a top plane 321 and a side surface 322 surrounding the top plane 321, and the side surface 322 is an arc-shaped surface. The arc-shaped surfaces of adjacent short lines 32 are connected to form the gap 33. By means of the arc-shaped surfaces, the gaps 33 become an optical structure, which produces optical effects under the effect of light.

In one embodiment, referring to FIGS. 4 and 10, there is at least one short line of the plurality of short lines 30, 32 that forms an included angle with the horizontal direction.

In one embodiment, referring to FIGS. 4 and 10, there are at least two short lines of the plurality of short lines 30, 32, that form included angles a and b with the horizontal direction, the included angle a being not equal to the included angle b.

A texture structure is provided on the optical thin film. According to different optical effects to be realized, the plurality of short lines 30, 32 can be rotated, so that the short lines are at different angles to realize the desired effect. The bottom plane 301 or the top plane 321 of the short lines 20, 32 is rectangular or substantially rectangular, and the short lines are deflected from the intersection point of the two diagonals of the rectangle. Preferably, the short lines 30, 32 in the same row are arranged to be deflected, and the deflection angles become greater successively, while the deflection angles of the short lines in the same column are the same. To be specific, the deflection angles of the short lines 30, 32 in the same row change in an equal difference manner, for example, the deflection angles are 0 to 180 degrees. Distances between the intersection points of adjacent short lines 30, 32 are equal.

In one embodiment, the plurality of short lines is arranged in a predetermined form. In one embodiment, the predetermined form is a linear type or a substantially linear type, and the short lines may also be arranged into other shapes.

In one embodiment, referring to FIGS. 4 and 10, the distance between adjacent short lines 30, 32 is 10 μm-200 μm.

In one embodiment, referring to FIGS. 4, 5 and 10, the short lines 30 in FIG. 4 and the short lines 34 in FIG. 5 are recessed structures, and the short lines 32 in FIG. 10 are protruded structures. The distance from the bottom plane of the short line 30 to the surface of the other side of the polymer layer is greater than 0 and less than 200 μm. Referring to FIG. 5, the distance from the bottom plane of the short lines 34 to the surface of the other side of the polymer layer 10 is 0, in other words, the short lines run through the polymer layer 10. In FIG. 10, the distance from the protruded top plane of the short lines 32 to the surface of the other side of the polymer layer is less than 200 μm.

In one embodiment, there are at least two short lines between which a height difference or depth difference is greater than 0.05 μm and not greater than 2 μm. Such a design can reduce the technology difficulty and can also realize the expected optical effect. Moreover, the optical effect brought by the height difference is difficult to be observed by human eyes.

In one embodiment, the short lines are protruded structures. In the plurality of short lines, there are at least two short lines that have a height difference, and the difference is greater than 2 μm and less than 100 μm. When the short lines are recessed structures, there are at least two short lines between which a depth difference is greater than 2 μm and less than 100 μm. Here, for the short lines, the height difference between the protrusions or the depth difference between the recesses are set to be relative large, which can produce different visual effects, enabling the optical thin film to have more plentiful visual effects to meet the demands of different users and bring more senses of change to customers.

Referring to FIGS. 4 and 10, the bottom plane 301 of the short line 30 or the top plane of the short line 32 is a rectangle, the length of the rectangle is 80 μm-150 μm, and the width of the rectangle is 1 μm-120 μm. In other embodiments, the length of the rectangle is constant and the width of the rectangle varies, for example, in a range of 3 μm-100 μm. Thus, varying optical effects can be presented to make the optical thin film have more plentiful visual effects, which can meet the demands of different users and bring more senses of change to the customers.

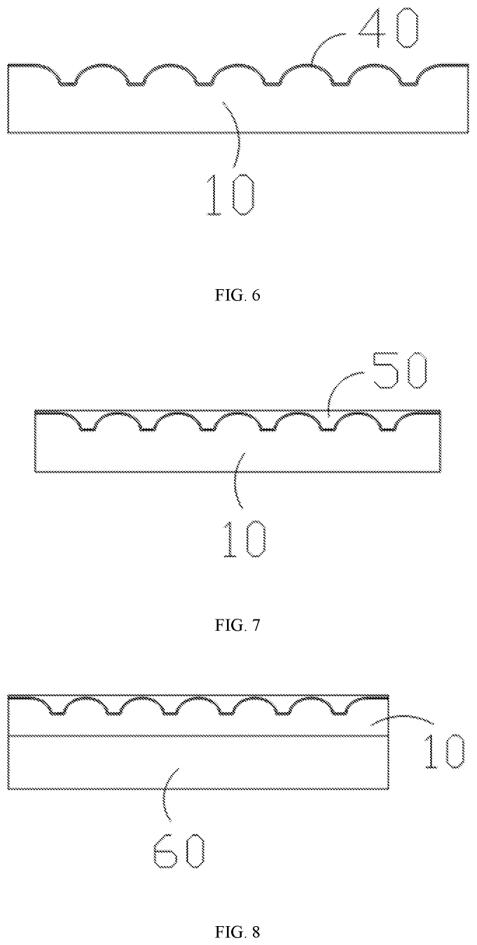

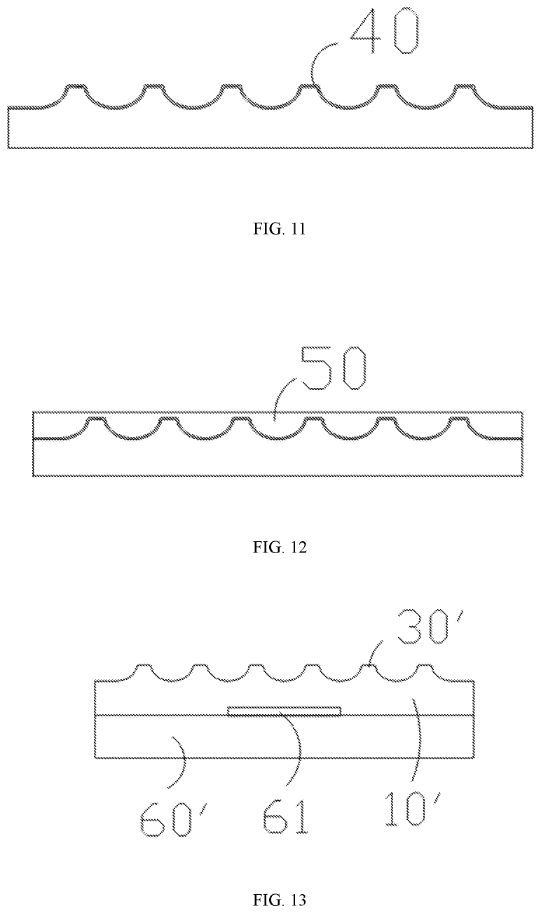

In one embodiment, referring to FIGS. 6 and 11, the texture structure is covered by a reflective layer 40. The reflective layer 40 can play a role of toning and/or reflecting. When a colored polymer is selected as the material of the polymer layer, the reflective layer 40 can only play the role of reflecting, or it can also play the role of toning together with the colored polymer layer 10.

In one embodiment, referring to FIGS. 7 and 12, the reflective layer 40 is covered by a colored layer 50. The colored layer 50 can be colored inks, used as a base, or used for toning in cooperation with the reflective layer.

In one embodiment, reference can be made to FIGS. 5 and 8 which may be a part of a laminated structure, and may also just be the section of an electronic device cover plate. The second side of the polymer layer 10 is provided with a carrying layer 60 which may be formed of a substrate material of PET, PC, PMMA, etc., and may also be formed of a substrate material of glass, metal, sapphire, etc.

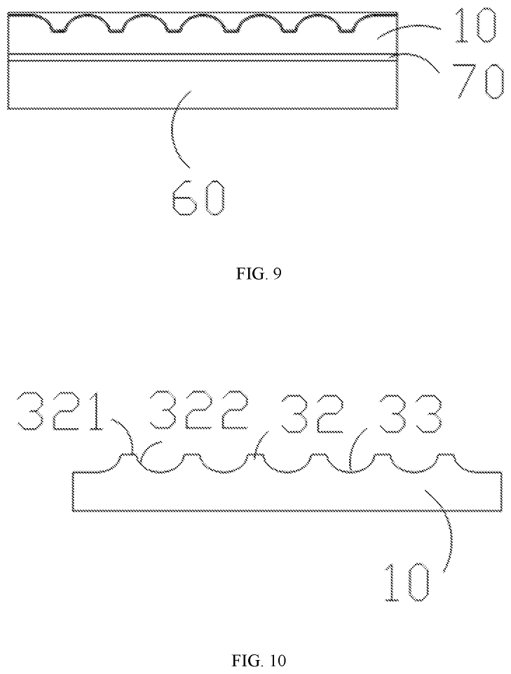

In one embodiment, referring to FIG. 9, an adhesive layer 70 is provided between the polymer layer 10 and the carrying layer 60. FIG. 9 may be a part of a laminated structure, and may also just be the section of an electronic device cover plate. The carrying layer 60 may be formed of a substrate material of PET, PC, PMMA, etc., and may also be formed of a substrate material of glass, metal, sapphire, etc.

In one embodiment, the optical thin film is a decorative film.

Referring to FIG. 13, the present invention discloses a mould for manufacturing an optical film. The mould comprises a supporting body 60′, a polymer body 10′ and a plurality of short lines 30′. The polymer body 10′ is disposed on one side of the supporting body 60′, and the plurality of short lines 30′ are formed on a side of the polymer body 10′ away from the supporting body 60′. The plurality of short lines 30′ are recessed structures and/or protruded structures. A gap exists between adjacent short lines 30′. The short line 30′ has a top plane or a bottom plane, as well as a side surface surrounding the top plane or bottom plane. The side surface is an arc-shaped surface, and the arc-shaped surfaces of adjacent short lines 30′ are connected to form the gap. In addition, a shielding layer 61 is provided between the supporting body 60′ and the polymer layer 10′. The shielding layer 61 is used to cover some regions of the mould which do not need to have a texture in the embossing process, so that the shielded regions will not be cured in the curing process.

Referring to FIG. 1, an electronic device cover plate 100 is provided, which at least comprises the texture structure in FIG. 3, and may also comprise a superposition of other texture structures, which may be a cylindrical mirror, a CD pattern, an Fresnel lens, a drawing line pattern, etc.

Referring to FIG. 1, an electronic device cover plate 100 is provided, which at least comprises the optical thin film disclosed in FIGS. 4 to 10.

The electronic device may be 3C products or household appliances, wherein, the 3C products include mobile phone, PAD, watch, computer, iPOD, camera, etc., and the household appliances include refrigerator, TV, air conditioner, washing machine, etc.

The technical solutions of the present invention at least have the following advantages.

(I) The present invention provides a new texture structure, of which the direction of the short lines can be changed in a certain direction randomly or according to a desired effect, and the included angles between the short lines and the horizontal direction can vary from 0 to 180 degrees. The side surface of the short line is an arc-shaped surface, adjacent arc-shaped surfaces connect with each other to form a gap, and the gaps are an optical structure.

(II) The present invention provides an optical thin film with this texture structure. The optical thin film using this texture at least has one light beam under a certain light source, and reduces to a certain extent the influence of rainbow streaks to the light-shadow effect.

(III) The present invention provides an electronic device cover plate using the texture structure or the optical thin film, by which the rotational angle of the short lines can be utilized flexibly to realize different light-shadow effects of the electronic device cover plate.

In order to make the above purpose, features and advantages of the present invention more obvious and easier to be understood, a detailed description of the specific embodiments of the present invention has been made in the above in combination the accompanying drawings. In the above description, a lot of specific details are elaborated for fully understanding the present invention. However, the present invention can be implemented by many other methods different from that mentioned above, thus a person skilled in the art can make similar improvements without violating the connotation of the present invention. Therefore, the present invention is not limited by the above disclosed specific embodiment. In addition, the technical features of the above embodiments can be combined randomly. For simplicity of description, not all possible combinations of the technical features in the above embodiments are described. However, as long as there is no contradiction in the combinations of these technical features, they should be regarded as being within the scope of disclosure contained in the present invention.

The above embodiments only express several embodiments of the present invention, which are described specifically and in detail, but they cannot be understood therefore as limitations to the patent scope of the present invention. What should be pointed out is that, for an ordinary skilled person in this field, on the premise of not deviating from the conception of the present invention, some deformations and improvements can be made, which belong to the protection scope of the present invention. Therefore, the scope of protection of the invention patent shall be subject to the attached claims.

What is claimed is:

1. A texture structure, wherein comprising a plurality of distributed short lines arranged to be protruded and/or recessed, a gap being formed between adjacent short lines, the gap forming an optical structure.

2. The texture structure according to claim 1, wherein there are at least two short lines forming included angles a and b with a horizontal direction, and the included angle a is not equal to the included Angle b.

3. The texture structure according to claim 1, wherein there are at least two short lines, of which one short line is deflected and/or offset with respect to the other.

4. The texture structure according to claim 3, wherein, the plurality of short lines are arranged in an array, the short lines in the same row are arranged to be deflected, and the deflection angle increases or decreases.

5. The texture structure according to claim 4, wherein, there is at least one region, in the same row, in which the deflection angles of the short lines change in an equal difference manner.

6. The texture structure according to claim 1, wherein, the short line includes a top plane or a bottom plane, and a side surface surrounding the top plane or bottom plane, the side surface being an arc-shaped surface.

7. The texture structure according to claim 6, wherein, the arc-shaped surfaces of two adjacent short lines are connected to form the gap.

8. The texture structure according to claim 6, wherein, the top plane or bottom plane of the short line is a rectangle and each short line is deflected from the intersection point of the two diagonals of the rectangle.

9. The texture structure according to claim 8, wherein, distances between the intersection points of adjacent short lines are equal.

10. The texture structure according to claim 6, wherein, the top plane or bottom plane of the short line is a rectangle, and in the same row, the length of the rectangle is constant while the width of the rectangle varies.

11. The texture structure according to claim 1, wherein, the optical structure presents at least one light-shadow bright streak.

12. An optical thin film having a texture structure according to claim 1, wherein, the optical thin film comprises a polymer layer on which the texture structure is formed.

13. The optical thin film according to claim 12, wherein, the polymer layer is a heat-cured or light-cured adhesive layer, the texture structure is the plurality of short lines formed by embossing on the heat-cured or light-cured adhesive layer and the gaps between the short lines.

14. The optical thin film according to claim 13, wherein, the light-cured adhesive layer is a UV adhesive layer; or the light-cured adhesive layer is a colored UV adhesive layer.

15. The optical thin film according to claim 12, wherein, there are at least two short lines between which a height difference or depth difference is greater than 0.05 μm but not greater than 2 μm.

16. The optical thin film according to claim 12, wherein, the short line has a top plane or a bottom plane, the top plane or bottom plane is a rectangle, the length of the rectangle is 80 μm-150 μm, and the width of the rectangle is 1 μm-120 μm.

17. The optical thin film according to claim 16, the length of the rectangle is constant, while the width of the rectangle varies in a range of 3 μm-100 μm.

18. The optical thin film according to claim 12, wherein, the texture structure is covered by a reflective layer, the reflective layer is covered by a colored layer, and a carrying layer is provided on a side of the polymer layer opposite to the texture structure.

19. The optical thin film according to claim 12, wherein the optical thin film is a decorative film.

20. An electronic device cover plate, wherein, the electronic device cover plate comprises an optical thin film according to claim 12.
